(19) United States
(12) Patent Application Publication
(10) Pub. No.: US 2009/0168694 A1
(43) Pub. Date: Jul. 2, 2009

(54) Breakout connection apparatus, system, and method

(75) Inventors: Marko Tapani Akselin, Oulu (FI); Marko Tapani Niemi, Oulu (FI); Jani Raimo Ensio Manninen, Oulu (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 12/003,651

(22) Filed: Dec. 28, 2007

(51) Int. Cl. H04Q 7/00

(52) U.S. Cl. 370/328

(57) ABSTRACT

A system includes a local mobile network and user equipment, where the user equipment is configured to detect a local network identity of a local mobile network, determine whether a selected condition involving the local network identity is satisfied, and indicate whether a breakout connection is appropriate based on whether the selected condition is satisfied. The breakout connection is appropriate when the selected condition is unsatisfied. A non-breakout connection is appropriate regardless of whether the selected condition is satisfied or unsatisfied In some embodiments, the selected condition is satisfied when the local network identity corresponds to a network identity of a home public land mobile network or an equivalent home public land mobile network.

### BACKGROUND OF THE INVENTION

1. Field of the Invention

The present invention relates generally to communication systems. More specifically, the present invention relates to breakout connection apparatuses, systems, and methods.

2. Description of the Related Art

User equipment is typically capable of establishing a connection with Home Public Land Mobile Networks (HPLMN) or Equivalent Home Public Land Mobile Networks (EHPLMN) which may include, for example, 3^{rd} Generation Partnership Program (3GPP) and Evolved Packet Systems (EPS) technologies. Establishing a connection with such networks is often facilitated by communications involving Home Subscriber Servers (HSS), Public Data Network Gateways (PDN GWs), and Access Point Names, and more.

However, though user equipment is typically capable of establishing a connection with HPLMNs or EHPLMNs, user equipment is often unable to directly establish a connection with local mobile networks that are not a HPLMN or a EHPLMN, i.e., while roaming away from home operator services. For example, current signaling charts and clauses in 3GPP stage 2 in 3GPP TS 23.401 specify that Mobility Management Entity (MME) tasks include choosing a PDN GW with information received from HSS. An inability to establish such a connection excludes the user equipment from the services that might otherwise be available. This exclusion from services is not only inconvenient, but may be hazardous in emergency situations.

### SUMMARY OF THE INVENTION

The present invention has been developed in response to the present state of the art, and in particular, in response to the problems and needs in the art that have not yet been fully solved by currently available identity migration solutions. Accordingly, the present invention has been developed to provide a breakout connection apparatus, a system, and a method.

In one aspect of the present invention, a method includes detecting a local network identity of a local mobile network, determining whether a selected condition involving the local network identity is satisfied, and indicating whether a breakout connection is appropriate based on whether the selected condition is satisfied, where the breakout connection is appropriate when the selected condition is unsatisfied.

In another aspect of the present invention, an apparatus includes a detector configured to detect a local network identity of a local mobile network, a processor configured to determine whether a selected condition involving the local network identity is satisfied, and an indicator configured to indicate whether a breakout connection is appropriate based on whether the selected condition is satisfied, where the breakout connection is appropriate when the selected condition is unsatisfied.

In another aspect of the present invention, a system includes a local mobile network and a user equipment. The user equipment is configured to detect a local network identity of a local mobile network, determine whether a selected condition involving the local network identity is satisfied, and indicate whether a breakout connection is appropriate based on whether the selected condition is satisfied, where the breakout connection is appropriate when the selected condition is unsatisfied.

In yet another aspect of the present invention, a computer program is embodied on a computer-readable medium. The computer program is configured to control a processor to perform operations including detecting a local network identity of a local mobile network, determining whether a selected condition involving the local network identity is satisfied, and indicating whether a breakout connection is appropriate based on whether the selected condition is satisfied, where the breakout connection is appropriate when the selected condition is unsatisfied.

In yet another aspect of the present invention, an apparatus includes detecting means for detecting a local network identity of a local mobile network, determining means for determining whether a selected condition involving the local network identity is satisfied, and indicating means for indicating whether a breakout connection is appropriate based on whether the selected condition is satisfied, where the breakout connection is appropriate when the selected condition is unsatisfied.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram of a breakout connection system, in accordance with one embodiment of the present invention;

FIG. 2 is a block diagram of a breakout connection apparatus, in accordance with one embodiment of the present invention;

FIG. 3 is a block diagram of a breakout connection apparatus, in accordance with one embodiment of the present invention;

FIG. 4 is a flow chart diagram of a breakout connection method, in accordance with one embodiment of the present invention; and

FIG. 5 is a flow chart diagram of a breakout connection method, in accordance with one embodiment of the present invention.

### DETAILED DESCRIPTION OF THE PREFERRED EMBODIMENT(S)

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in the attached Figures, is not intended to limit the scope of the invention, as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

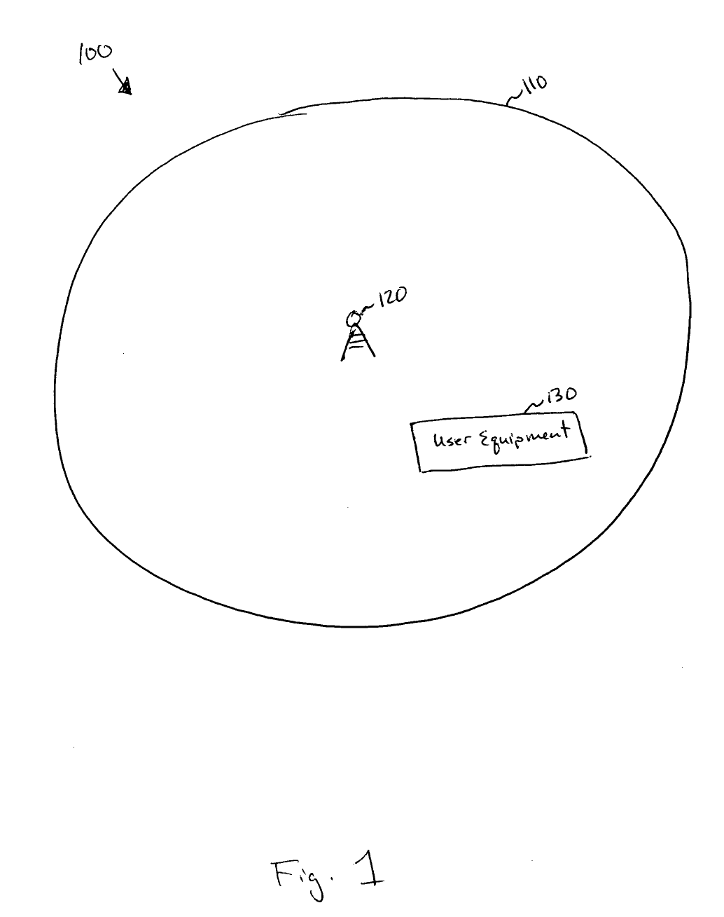

FIG. 1 is a block diagram of one embodiment of a breakout connection system 100, in accordance with one embodiment of the present invention. The depicted system 100 includes a local mobile network 110 and a user equipment 130. The local mobile network 110 communicates with the user equipment via a base station 120. The components of the system 110 cooperate to enable establishing a breakout connection.

In certain embodiments, the user equipment 130 may detect a local network identity of the local mobile network 110. In some embodiments, the local mobile network 110 may broadcast the local network identity to the user equipment 130. In certain embodiments, the user equipment 130 may determine whether a selected condition involving the local network identity is satisfied, and indicates whether a breakout connection is appropriate based on whether the selected condition is satisfied. In some embodiments, the selected condition may include whether the local network identity is the same as, or otherwise corresponds to, a network identity known to the user equipment 130. It should be appreciated that the selected condition could be defined in many ways, not limited by a comparison of one network identity with another. In some embodiments, the breakout connection is appropriate when the selected condition is unsatisfied. In certain embodiments, a non-breakout connection is appropriate regardless of whether the selected condition is satisfied or unsatisfied. In some embodiments, a breakout connection and a non-breakout connection may both be appropriate.

In certain embodiments, the selected condition is unsatisfied if the user equipment 130 does not recognize the local network identity 110. In some embodiments, indicating the appropriate connection as a breakout connection is followed by the user equipment 130 requesting and establishing a breakout connection with the local mobile network 110. A breakout connection may include, but is not limited to, a direct connection with a local mobile network that is a visited or non-home network. Accordingly, the depicted system 100 provides one embodiment of a breakout connection system in accordance with the present invention.

Depending upon the embodiment, aspects of the system 100 may include a variety of technologies including technologies related to Evolved Packet Systems (EPS), Public Data Network (PDN) Gateways (GW), and the 3^{rd} Generation Partnership Program (3GPP). In certain embodiments, the local mobile network 110 may include a Home Public Land Mobile Network (HPLMN) or an Equivalent Home Public Land Mobile Network (EHPLMN). In other embodiments, the local mobile network 110 may include a local mobile network that is not a HPLMN or a EHPLMN, or a mobile network that is excluded from a Home Subscriber Server (HSS). In some embodiments, the local network identity may include a Public Land Mobile Network (PLMN) Identity (ID). Additionally, user equipment 130 may include a cellular phone, a palm pilot, a wireless computer, or any variety of device capable of performing the operations and/or including the features disclosed herein.

In certain embodiments, a non-breakout connection is appropriate regardless of whether the selected condition is satisfied or unsatisfied. In some embodiments, the user equipment 130 is also configured to request and establish a non-breakout connection with the local mobile station regardless of whether the selected condition is satisfied. A non-breakout connection may includes a connection with a home network of the user equipment 130. In some embodiments, the user equipment 130 is configured to compare the local network identity to at least one other network identity to determine whether the selected condition is satisfied

In some embodiments, the user equipment 130 compares the local network identity other network identities to determine whether the selected condition is satisfied. The selected condition may be satisfied when the local network identity corresponds to at least one of the other network identities. In some embodiments, the user equipment 130 store the other local identities locally. In certain embodiments, the user equipment 130 receives the network identity from a public land mobile network broadcast of the local mobile network 110.

With respect to the present invention, a user equipment may be any device such as a mobile device that utilizes network data, and can include switches, routers, bridges, gateways or servers. In addition, while the terms, data, packet, and/or datagram have been used in the description of the present invention, the invention has import to many types of network data. For purposes of this invention, the term data includes packet, cell, frame, datagram, bridge protocol data unit packet, packet data and any equivalents thereof.

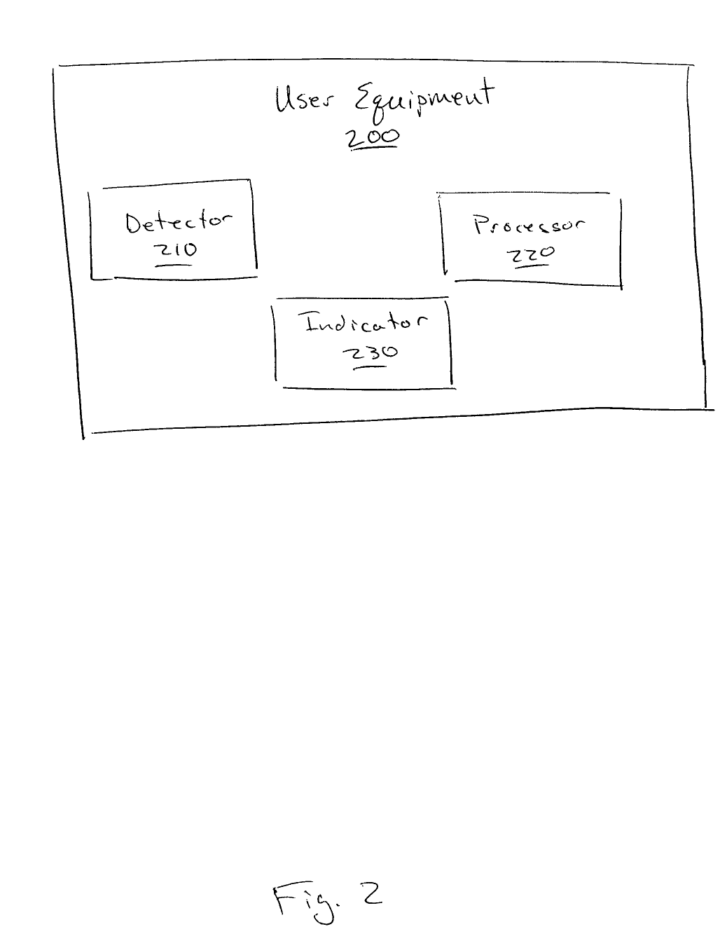

FIG. 2 is a block diagram of a breakout connection apparatus 200, in accordance with an embodiment of the present invention. The depicted apparatus 200 includes a detection unit, or a detector 210, a determination unit, or a processor 220, and an indication unit, or an indictor 320. In certain embodiments, the apparatus 200 corresponds to the user equipment 130 of FIG. 1. The components of the apparatus 200 cooperate to indicate an opportunity for a breakout connection.

In certain embodiments, the detector 210 detects a local network identity of a local mobile network. In certain embodiments, the detector 210 may include a wireless network interface capable of receiving a local network identity from a local mobile network. In certain embodiments, the local network identity may include a Public Land Mobile Network (PLMN) Identitiy (ID) of a local mobile network that is not a HPLMN or a EHPLMN.

In some embodiments, the processor 220 determines whether a selected condition involving the local network identity is satisfied. In some embodiments, the processor 220 compares the network identity to other network identities to determine whether the selected condition is satisfied. In certain embodiments, the selected condition is satisfied if the local network identity corresponds to one or more network identities known to the apparatus 200 such as a PLMN ID of a HPLMN or a EHPLMN. In some embodiments, the selected condition is unsatisfied if the local network identity is not known to the apparatus 200 such as a PLMN ID of a local mobile network detected while the apparatus 200 is roaming.

In certain embodiments, the indicator 230 indicates whether a breakout connection is appropriate based on whether the selected condition is satisfied. A breakout connection may be appropriate when the selected condition is unsatisfied. Depending on the embodiment, the indicator 230 may accomplish this on a high level, such as displaying a message in a user interface, or on a lower level, such as signaling another component of the apparatus 200, a circuit or logical structure (not shown) of the apparatus, or the local mobile network. In some embodiments, in addition to indicating a breakout connection, the apparatus 200 may request and establish a breakout connection with the local mobile network (not shown). In certain embodiments, a request to establish a breakout connection may be part of an attach request. Accordingly, the apparatus 200 depicted in FIG. 2 provides one embodiment of a breakout connection apparatus in accordance with the present invention.

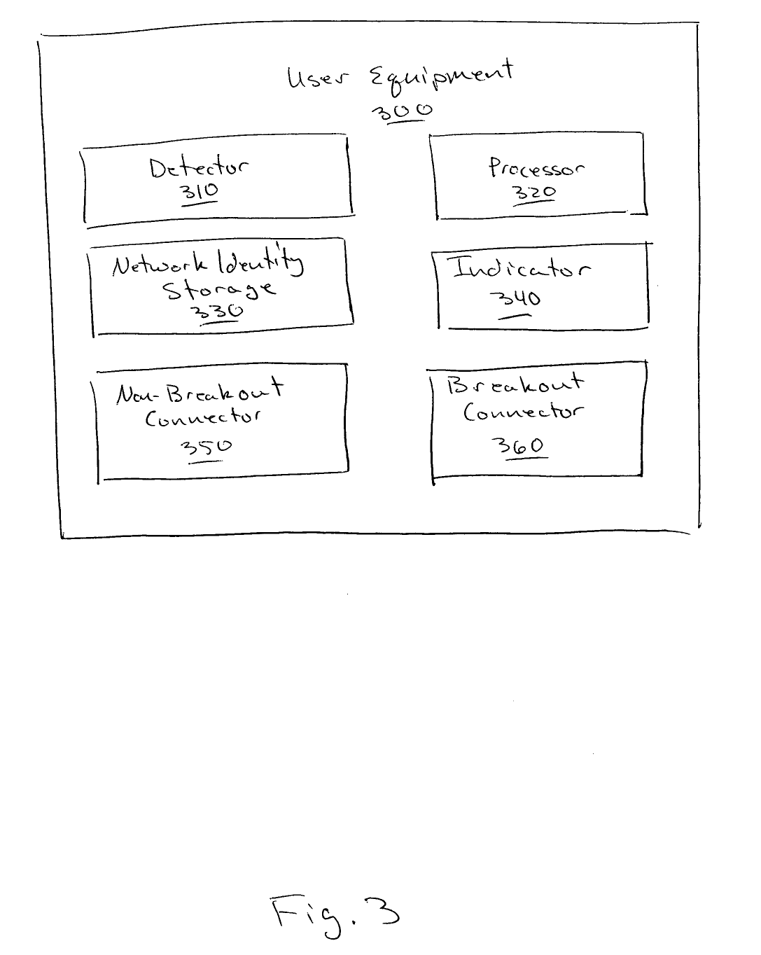

FIG. 3 is a block diagram a breakout connection apparatus 300, in accordance with one embodiment of the present invention. The depicted apparatus 300 includes a detection unit, or detector 310, a determination unit, or processor 320, a network identity storage unit, or network identity storage 330, an indication unit, or indicator 340, a non-breakout connection unit, or non-breakout connector 350, and a breakout connection unit, or breakout connector 360. In certain embodiments, the apparatus 300 corresponds to the user equipment 130 of FIG. 1. The components of the apparatus 300 cooperate to establish an appropriate connection, which may include a breakout connection.

In certain embodiments, the detector 310 detects a local network identity of a local mobile network and the processor 320 determines whether a selected condition involving the local network identity is satisfied. This may include the processor 320 comparing the local network identity with other network identifies stored in the network identity storage 330. In certain embodiments, the network identities stored in the network identity storage 330 may be updated, changed, or otherwise altered in any way.

In certain embodiments, the indicator 340 may indicate whether a breakout connection is appropriate based on whether the selected condition is satisfied. A breakout connection may be appropriate when the selected condition is unsatisfied. In some embodiments, the breakout connector 360 may request and establish a breakout connection with the local mobile network corresponding to the local network identity. In certain embodiments, the non-breakout connector may request and/or establish a connection with the local mobile network regardless of whether the selected condition is satisfied. Accordingly, in certain embodiments, a breakout connection and non-breakout connection may concurrently formed.

In certain embodiments, the features and operations described above may include Radio Access Network (RAN) layers of user equipment indicating to upper layers of user equipment about a local network identity of the local mobile network. The upper layers of the user equipment may compare a PLMN ID with HPLMN and EHPLMN IDs stored in a Universal Subscriber Identity Module (USIM). The present document makes no distinction between Subscriber Identity Module (SIM) and USIM. The user equipment may indicate an opportunity for a local breakout connection.

Many of the functional units described in this specification have been labeled as units, in order to more particularly emphasize their implementation independence. For example, a unit may be implemented as a hardware circuit comprising custom VLSI circuits or gate arrays, off-the-shelf semiconductors such as logic chips, transistors, or other discrete components. A unit may also be implemented in programmable hardware devices such as field programmable gate arrays, programmable array logic, programmable logic devices or the like.

Units may also be implemented in software for execution by various types of processors. An identified unit of executable code may, for instance, comprise one or more physical or logical blocks of computer instructions which may, for instance, be organized as an object, procedure, or function. Nevertheless, the executables of an identified unit need not be physically located together, but may comprise disparate instructions stored in different locations which, when joined logically together, comprise the unit and achieve the stated purpose for the unit.

Indeed, a unit of executable code could be a single instruction, or many instructions, and may even be distributed over several different code segments, among different programs, and across several memory devices. Similarly, operational data may be identified and illustrated herein within units, and may be embodied in any suitable form and organized within any suitable type of data structure. The operational data may be collected as a single data set, or may be distributed over different locations including over different storage devices, and may exist, at least partially, merely as electronic signals on a system or network.

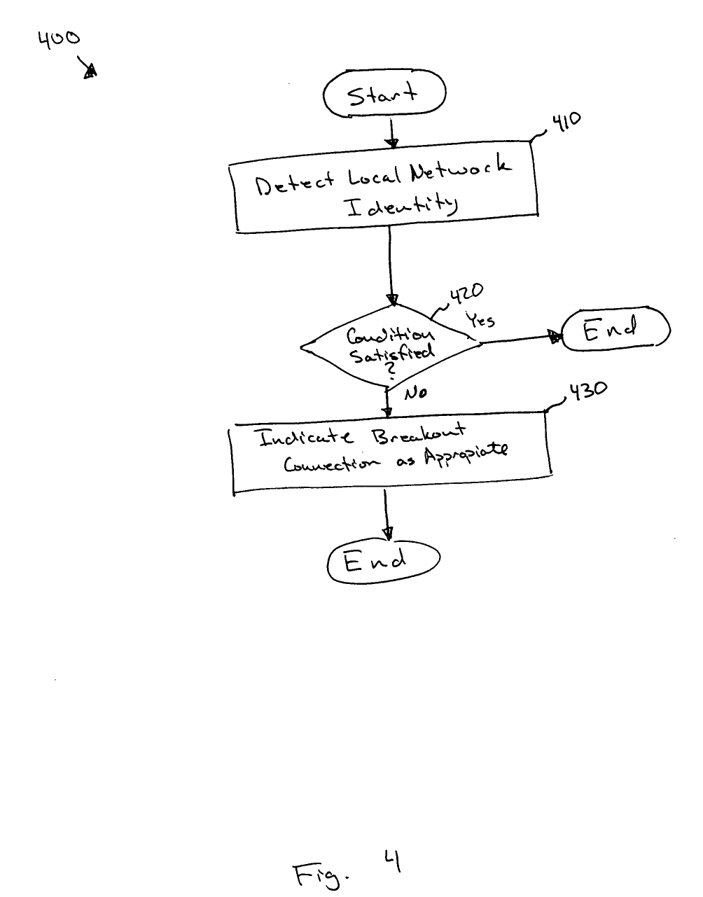

FIG. 4 is a flow chart diagram of one embodiment of a breakout connection method 400, in accordance with one embodiment of the present invention. The depicted method 400 includes detecting 410 a local network identity, determining 420 if a selected condition is satisfied, and indicating 430 a breakout connection as appropriate if the selected condition is unsatisfied. The operations of the method 400 cooperate to indicate whether a breakout connection is appropriate.

Detecting 410 a local network identity may include receiving a data stream from a local mobile network via a wireless connection that includes the local network identity. Determining 420 if a selected condition is satisfied may include comparing the local network identity received from the local mobile network with other network identities. In certain embodiments, the selected condition is satisfied if the local network identity is the same as, or otherwise corresponds to, a known local mobile network. It should be appreciated that the comparison relationship between the local network identity and the other network identities could be defined in many ways. The method 400 continues by indicating 430 that a local breakout connection is appropriate if the selected condition is unsatisfied.

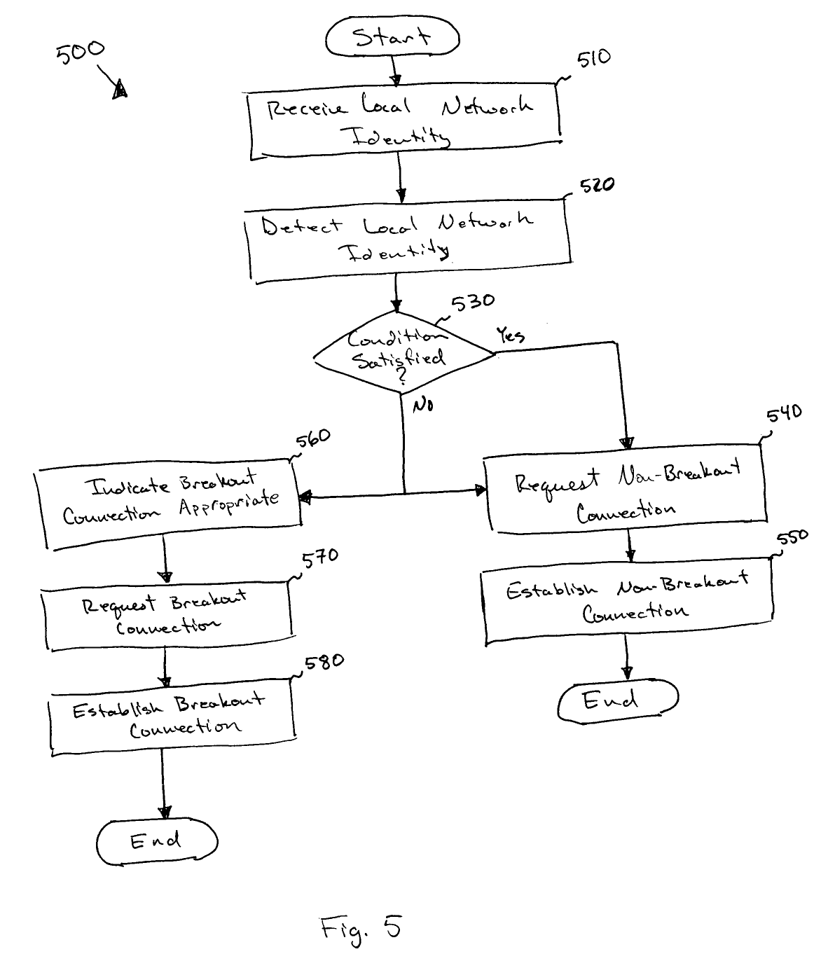

FIG. 5 is a flow chart diagram of a breakout connection method 500, in accordance with one embodiment of the present invention. The depicted method 500 includes requesting 510 a non-breakout connection, establishing 520 a non-breakout connection, receiving 530 a local network identity, detecting 540 the local network identity, determining 550 whether a selected condition is satisfied, and, if the selected condition is unsatisfied, indicating 560 a breakout connection, requesting 570 a breakout connection, and establishing 580 a breakout connection. In certain embodiments, the method 500 may correspond to 3^{rd} Generation Partnership Program operations. The operations of the method 500 may cooperate to establish a non-breakout connection and additionally, if a selected condition is unsatisfied, a breakout connection.

Receiving 510 a local network identity may include a user equipment receiving a local network identity from a public land mobile network broadcast of the local mobile network. Detecting 520 a local network identity may include a user equipment detecting the reception of the local network identity of the local mobile network. Determining 530 whether a selected condition is satisfied may include determining whether the local network identity corresponds to a known network identity, which may include comparing the local network identity to other network identities. In certain embodiments, the selected condition is satisfied if the local network identity corresponds to a known network identity.

If the selected condition is unsatisfied, i.e., the local network identity is not known, then the method 500 continues by indicating 570 that a breakout connection is appropriate. Once a breakout connection is indicated as appropriate, then a breakout connection from the local mobile connection may be requested 580 and established 590. In addition to indicating 560, requesting 570, and establishing 580 a breakout connection, the method 500 also discloses requesting 540 and establishing 550 a non-breakout connection when the selected condition is unsatisfied. Accordingly, the method 500 provides a solution for establishing a breakout and non-breakout connection depending on the local network identity received from the local mobile network.

In some embodiments, the other network identities to which the local network identity is compared include identities of a home public mobile network and/or an equivalent home public land mobile network. In such embodiment, the selected condition may be satisfied if the local mobile network identity corresponds to one of the other network identities. In certain embodiments, the method may include storing other network identities to facilitate determining 520 whether the selected condition is satisfied. As depicted, in certain embodiments, a non-breakout connection may always be appropriate regardless of whether the selected condition is satisfied.

In accordance with the present invention, the local network identity may be received from a broadcast (i.e., before attachment). Accordingly, the determining of whether the selected condition is satisfied (i.e., comparing the local network identity with other network identities) and the indicating that a breakout connection is appropriate may be executed in conjunction with attachment operations.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

We claim:

1. A method comprising:
detecting a local network identity of a local mobile network;
determining whether a selected condition involving the local network identity is satisfied; and
indicating whether a breakout connection is appropriate based on whether the selected condition is satisfied,
wherein the breakout connection is appropriate when the selected condition is unsatisfied.

2. The method of claim 1, wherein a non-breakout connection is appropriate regardless of whether the selected condition is satisfied.

3. The method of claim 1, wherein the determining of whether the selected condition is satisfied comprises comparing the local network identity to at least one other network identity.

4. The method of claim 3, further comprising:
determining that the selected condition is satisfied when the local network identity corresponds to the at least one other network identity.

5. The method of claim 4, wherein the at least one other network identity comprises a network identity of a home public land mobile network or an equivalent home public land mobile network.

6. The method of claim 4, further comprising:
storing the at least one other network identity locally.

7. The method of claim 1, further comprising:
requesting the breakout connection with the local mobile connection when the selected condition is unsatisfied.

8. The method of claim 1, further comprising:
receiving the local network identity from a public land mobile network broadcast of the local mobile network.

9. The method of claim 1, further comprising:
establishing the break out connection with the local mobile connection with the local mobile network when the selected condition is unsatisfied.

10. The method of claim 1, further comprising:
requesting a non-breakout connection regardless of whether the selected condition is satisfied.

11. The method of claim 1, further comprising:
establishing a non-breakout connection with the local mobile connection regardless of whether the selected condition is satisfied.

12. The method of claim 1, wherein the local mobile network corresponds to a 3^{rd} generation partnership program mobile network.

13. An apparatus comprising:
a detector configured to detect a local network identity of a local mobile network;
a processor configured to determine whether a selected condition involving the local network identity is satisfied; and
an indicator configured to indicate whether a breakout connection is appropriate based on whether the selected condition is satisfied,
wherein the breakout connection is appropriate when the selected condition is unsatisfied.

14. The apparatus of claim 13, wherein a non-breakout connection is appropriate regardless of whether the selected condition is satisfied or unsatisfied.

15. The apparatus of claim 13, wherein the processor is configured to compare the local network identity to at least one other network identity to determine whether the selected condition is satisfied.

16. The apparatus of claim 14, wherein the selected condition is satisfied when the local network identity corresponds to the at least one other network identity.

17. The apparatus of claim 16, wherein the at least one other network identity comprises a network identity of a home public land mobile network or an equivalent home public land mobile network.

19. The apparatus of claim 16, further comprising:
a network identity storage configured to store the at least one other network identity locally.

20. The apparatus of claim 13, further comprising:
a reception unit configured to receive the local network identity from a public land mobile network broadcast of the local mobile network.

21. The apparatus of claim 13, further comprising:
a breakout connector configured to request a breakout connection when the selected condition is unsatisfied.

22. The apparatus of claim 13, further comprising:
a breakout connector configured to establish a breakout connection with the local mobile network when the selected condition is unsatisfied.

23. The apparatus of claim 13, further comprising:
a non-breakout connector configured to request a non-breakout connection regardless of whether the selected condition is satisfied.

24. The apparatus of claim 13, further comprising:
a non-breakout connector configured to establish a non-breakout connection with the local mobile network regardless of whether the selected condition is satisfied.

25. The apparatus of claim 13, wherein the local mobile network corresponds to a 3^{rd} generation partnership program mobile network.

26. A system comprising:
a local mobile network; and
a user equipment configured to
detect a local network identity of a local mobile network,
determine whether a selected condition involving the local network identity is satisfied, and
indicate whether a breakout connection is appropriate based on whether the selected condition is satisfied,
wherein the breakout connection is appropriate when the selected condition is unsatisfied.

27. The system of claim 26, wherein a non-breakout connection is appropriate regardless of whether the selected condition is satisfied or unsatisfied.

28. The system of claim 26, wherein the user equipment is configured to compare the local network identity to at least one other network identity to determine whether the selected condition is satisfied.

29. The system of claim 28, wherein the selected condition is satisfied when the local network identity corresponds to the at least one other network identity.

30. The system of claim 29, wherein the at least one other network identity comprises a network identity of a home public land mobile network or an equivalent home public land mobile network.

31. The system of claim 29, wherein the user equipment is further configured to store the at least one other network identity locally.

32. The system of claim 26, wherein the user equipment is configured to receive the network identity from a public land mobile network broadcast of the local mobile network.

33. The system of claim 26, wherein the user equipment is further configured to request the breakout connection with the local mobile network when the selected condition is unsatisfied.

34. The system of claim 26, wherein the user equipment is further configured to establish the breakout connection with the local mobile network when the selected condition is unsatisfied.

35. The system of claim 26, wherein the user equipment is further configured to request a non-breakout connection with the local mobile station regardless of whether the selected condition is satisfied.

36. The system of claim 26, wherein the user equipment is further configured to establish a non-breakout connection with the local mobile station regardless of whether the selected condition is satisfied.

37. The system of claim 26, wherein the local mobile network corresponds to a 3^{rd} generation partnership program mobile network.

38. A computer program embodied on a computer-readable medium, the computer program configured to control a processor to perform operations comprising:
detecting a local network identity of a local mobile network;
determining whether a selected condition involving the local network identity is satisfied; and
indicating whether a breakout connection is appropriate based on whether the selected condition is satisfied,
wherein the breakout connection is appropriate when the selected condition is unsatisfied.

39. An apparatus comprising:
detecting means for detecting a local network identity of a local mobile network;
determining means for determining whether a selected condition involving the local network identity is satisfied; and
indicating means for indicating whether a breakout connection is appropriate based on whether the selected condition is satisfied,
wherein the breakout connection is appropriate when the selected condition is unsatisfied.
